(19) United States
(12) Patent Application Publication
(10) Pub. No.: US 2016/0321869 A1
(43) Pub. Date: Nov. 3, 2016

(54) GAMING SYSTEM, GAMING DEVICE, AND METHOD OF GAMING

(71) Applicant: Casino Over Under, LLC, Tampa, FL (US)

(72) Inventor: Jason R. Kobal, Tampa, FL (US)

(21) Appl. No.: 14/864,282

(22) Filed: Sep. 24, 2015

Related U.S. Application Data
(60) Provisional application No. 62/155,110, filed on Apr. 30, 2015.

(51) Int. Cl. G07F 17/32; A63F 13/00

(52) U.S. Cl. CPC G07F 17/3244; A63F 13/00; A63F 2001/008

(57) ABSTRACT

Gaming systems, gaming devices, and methods of gaming which include accepting a primary wager from a player; dealing a first playing card; allowing the player to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold; dealing the player two additional playing cards; and then settling the player's wagers based on the sum of the numerical values of the player's three playing cards and whether the player placed an over wager or an under wager.

### PRIORITY/CROSS-REFERENCE TO RELATED APPLICATIONS

This application claims the benefit of U.S. Provisional Application No. 62/155,110, filed Apr. 30, 2015, the disclosure of which is incorporated by reference.

### TECHNICAL FIELD

The disclosure generally relates to the fields of gaming systems, gaming devices, and methods of gaming. Particular embodiments relate to gaming systems, gaming devices, and methods of gaming using the concept of over-under from sports gambling.

### BACKGROUND

Blackjack, also known as twenty-one, is the most widely played casino banking game in the world. Blackjack is a comparing card game between a player and dealer, meaning players compete against the dealer but not against other players. It is played with one or more decks of fifty-two playing cards. The object of the game is to beat the dealer in one of the following ways: (a) get twenty-one points on the player's first two cards (called a blackjack), without a dealer blackjack; (b) reach a final score higher than the dealer without exceeding twenty-one; or (c) let the dealer draw additional cards until the dealer's hand exceeds twenty-one. The player or players are dealt a two-card hand and add together the value of their cards. Face cards (kings, queens, and jacks) are counted as ten points. A player and the dealer can count an ace as one point or eleven points. All other cards are counted as the numeric value shown on the card. After receiving their first two cards, players have the option of getting a “hit,” or taking an additional card. In a given round, the player or the dealer wins by having a score of twenty-one or by having the higher score that is less than twenty-one. Scoring higher than twenty-one (called “busting” or “going bust”) results in a loss. A player may win by having any final score equal to or less than twenty-one if the dealer busts. The dealer must hit until the cards total seventeen or more points. Players win by not busting and having a total higher than the dealer's. The dealer loses by busting or having a lesser hand than the player who has not busted. If the player and dealer have the same total, this is called a “push,” and the player typically does not win or lose money on that hand.

An over-under or over/under (O/U) bet is a wager in which a sportsbook will predict a number for a statistic in a given game (usually the combined score of the two teams), and bettors wager that the actual number in the game will be either higher or lower than that number.

### SUMMARY OF THE DISCLOSURE

Several exemplary gaming systems, gaming devices, and methods of gaming using the concept of over-under from sports gambling are described herein.

A first exemplary electronically implemented method of playing a casino game using images of playing cards is disclosed. The first exemplary electronically implemented method utilizes an electronic gaming machine which includes at least one display screen configured to display images of playing cards, the electronic gaming machine includes a non-transitory computer-readable medium coded with instructions executed by a processor. Playing positions on the display screen for at least one player are established. Electronically producible images of at least one standard deck of fifty-two playing cards with respective faces designated in ascending numerical sum 2-10, J, Q, K, A each in four suits is provided, and a numerical value to each playing card, the numerical value being equivalent to the face value for playing cards designated 2-10, the numerical value being ten for playing cards designated J, Q, K, and the numerical value being eleven for playing cards designated A, is assigned. In the method, a primary wager is accepted from a player, either before or after the player is dealt any playing cards. The player is then dealt a first playing card, and the player is allowed to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold. The act of folding resulting in the confiscation of the player's primary wager. The player is then dealt the two additional playing cards. The player's primary wager, and the player's over wager or under wager are settled dependent upon the sum of the numerical values of the player's three playing cards. The settlement step including confiscating the player's primary wager and any over wager or under wager made by the player if the sum of the numerical values is any numerical value greater than or equal to the second numerical value, and less than or equal to the first numerical value, regardless of whether the player placed an over wager or placed an under wager. The settlement step includes confiscating the player's primary wager and the player's over wager if the sum of the numerical values is less than or equal to the first numerical value and the player placed an over wager. The settlement step includes confiscating the player's primary wager and the player's under wager if the sum of the numerical values is greater than or equal to the second numerical value and the player placed an under wager. The settlement step includes paying the player a winning payout associated with the player's primary wager and the player's under wager if the sum of the numerical values is less than the second numerical value and the player placed an under wager. The settlement step includes paying the player a winning payout associated with the player's primary wager and the player's over wager if the sum of the numerical values is greater than the first numerical value and the player placed an over wager. Optionally, the first numerical value is 23, wherein the second numerical value is 18. Optionally, the over wager is equal to the primary wager, and the under wager is equal to the primary wager. Optionally, all three cards could be dealt at the same time.

A second exemplary electronically implemented method of playing a casino game using images of playing cards is disclosed. The second exemplary electronically implemented method is similar to the first exemplary electronically implemented method, but further includes accepting a bonus wager from the player. The settlement step includes confiscating the player's bonus wager if the sum of the numerical values is any numerical value greater than or equal to the second numerical value, and less than or equal to the first numerical value. The settlement step includes confiscating the player's bonus wager if the sum of the numerical values is less than or equal to the first numerical value and the player placed an over wager. The settlement step includes confiscating the player's bonus wager if the sum of the numerical values is greater than or equal to the second numerical value and the player placed an under wager. The settlement step includes paying the player a winning payout associated with the player's bonus wager if the sum of the numerical values is less than the second numerical value and the player placed an under wager. The settlement step includes paying the player a winning payout associated with the player's bonus wager if the sum of the numerical values is greater than the first numerical value and the player placed an over wager. Optionally, the first numerical value is 23, and the second numerical value is 18. Optionally, the over wager is equal to the primary wager, and the under wager is equal to the primary wager. Optionally, the bonus wager could not be confiscated before the second and third cards are revealed, and the bonus wager could be settled based upon the sum of the numerical value of the cards. Optionally, all three cards could be dealt at the same time.

A first exemplary method of playing a casino table game using playing cards is also disclosed. In the first exemplary method of playing a casino table game, at least one standard deck of fifty-two playing cards with respective faces designated in ascending numerical sum 2-10, J, Q, K, A each in four suits is provided. A numerical value is assigned to each playing card, the numerical value being equivalent to the face value for playing cards designated 2-10, the numerical value being ten for playing cards designated J, Q, K, and the numerical value being eleven for playing cards designated. A primary wager is accepted from the player. The player is dealt a first playing card. The player is allowed to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold. The act of folding results in the confiscation of the player's primary wager. The player is then dealt the two additional playing cards. The player's primary wager, and the player's over wager or under wager are settled dependent upon the sum of the numerical values of the player's three playing cards. The settlement step including confiscating the player's primary wager and any over wager or under wager made by the player if the sum of the numerical values is any numerical value greater than or equal to the second numerical value, and less than or equal to the first numerical value, regardless of whether the player placed an over wager or placed an under wager. The settlement step includes confiscating the player's primary wager and the player's over wager if the sum of the numerical values is less than or equal to the first numerical value and the player placed an over wager. The settlement step includes confiscating the player's primary wager and the player's under wager if the sum of the numerical values is greater than or equal to the second numerical value and the player placed an under wager. The settlement step includes paying the player a winning payout associated with the player's primary wager and the player's under wager if the sum of the numerical values is less than the second numerical value and the player placed an under wager. The settlement step includes paying the player a winning payout associated with the player's primary wager and the player's over wager if the sum of the numerical values is greater than the first numerical value and the player placed an over wager. Optionally, the first numerical value is 23, wherein the second numerical value is 18. Optionally, the over wager is equal to the primary wager, and the under wager is equal to the primary wager. Optionally, all three cards could be dealt at the same time.

A second exemplary method of playing a casino table game using playing cards is also disclosed. The second exemplary method of playing a casino table game is similar to the first exemplary method of playing a casino table game, but further includes accepting a bonus wager from the player. The settlement step includes confiscating the player's bonus wager if the sum of the numerical values is any numerical value greater than or equal to the second numerical value, and less than or equal to the first numerical value. The settlement step includes confiscating the player's bonus wager if the sum of the numerical values is less than or equal to the first numerical value and the player placed an over wager. The settlement step includes confiscating the player's bonus wager if the sum of the numerical values is greater than or equal to the second numerical value and the player placed an under wager. The settlement step includes paying the player a winning payout associated with the player's bonus wager if the sum of the numerical values is less than the second numerical value and the player placed an under wager. The settlement step includes paying the player a winning payout associated with the player's bonus wager if the sum of the numerical values is greater than the first numerical value and the player placed an over wager. Optionally, the first numerical value is 23, and the second numerical value is 18. Optionally, the over wager is equal to the primary wager, and the under wager is equal to the primary wager. Optionally, the bonus wager could not be confiscated before the second and third cards are revealed, and the bonus wager could be settled based upon the sum of the numerical value of the cards. Optionally, all three cards could be dealt at the same time.

Additional understanding of the devices and methods contemplated and/or claimed by the inventor can be gained by reviewing the detailed description of exemplary devices and methods, presented below, and the referenced drawings.

### BRIEF DESCRIPTION OF THE DRAWINGS

FIG. 1 is a front side view of a first exemplary gaming machine.

FIG. 2 is a block diagram of an exemplary computer system.

FIG. 3 is a drawing illustrating an exemplary table layout, according to an embodiment.

FIG. 4 is a flow chart of a method according to a preferred embodiment of the invention.

FIG. 5 is a flow chart of a second method according to a preferred embodiment of the invention.

FIG. 6 is a flow chart of a third method according to a preferred embodiment of the invention.

FIG. 7 is a flow chart of a fourth method according to a preferred embodiment of the invention.

### DEFINITIONS

The following terms have the following meanings when used herein.

The use of “e.g.,” “etc,” “for instance,” “in example,” “for example,” and “or” and grammatically related terms indicates non-exclusive alternatives without limitation, unless the context clearly dictates otherwise.

The use of “including” and grammatically related terms means “including, but not limited to,” unless the context clearly dictates otherwise.

The use of the articles “a,” “an” and “the” are meant to be interpreted as referring to the singular as well as the plural, unless the context clearly dictates otherwise. Thus, for example, reference to “a wager” includes two or more such wagers, and the like.

The use of “optionally,” “alternatively,” and grammatically related terms means that the subsequently described element, event or circumstance may or may not be present/occur, and that the description includes instances where said element, event or circumstance occurs and instances where it does not, unless the context clearly dictates otherwise.

The use of “preferred,” “preferably,” and grammatically related terms means that a specified element or technique is more acceptable than another, but not that such specified element or technique is a necessity, unless the context clearly dictates otherwise.

The use of “exemplary” means “an example of” and is not intended to convey a meaning of an ideal or preferred embodiment, unless the context clearly dictates otherwise.

Words of approximation (e.g., “substantially,” “generally”), as used in context of the specification and figures, are intended to take on their ordinary and customary meanings which denote approximation, unless the context clearly dictates otherwise.

The use of “wager” (as a verb) means to place something of value (money or other consideration) at risk of loss for the opportunity to obtain a benefit, usually additional money or other consideration, unless the context clearly dictates otherwise.

The use of “wager” (as a noun) means an amount of money or other consideration that is placed at risk of loss, unless the context clearly dictates otherwise. In some embodiments, a wager can comprise a token or tokens of nominal value.

The use of “primary wager” means a wager placed at the beginning of a round of play, unless the context clearly dictates otherwise. An ante is an example of a primary wager.

The use of “betting field” comprises an area, either in physical form or displayed electronically, in which a wager is placed or displayed, unless the context clearly dictates otherwise.

The use of “bonus wager” means a wager placed on the betting field seeking a payout from a bonus table, unless the context clearly dictates otherwise.

The use of “over wager” means a wager placed on the betting field wagering that the sum of the numerical values of playing cards in a round will be greater than a first numerical value, unless the context clearly dictates otherwise.

The use of “under wager” means a wager placed on the betting field wagering that the sum of the numerical values of playing cards in a round will be less than a first numerical value, unless the context clearly dictates otherwise.

The use of “fold” means to the act of ending participation in a game or in a portion of a game, unless the context clearly dictates otherwise.

The use of “player” means to an individual or other gaming entity which engages in playing the game, unless the context clearly dictates otherwise.

The use of “gaming machine” means an electronic device upon which the gaming systems and methods of gaming disclosed herein can be operated or displayed, unless the context clearly dictates otherwise. Examples of gaming machines include, but are not limited to, video game machines, gambling machines (e.g., slot machines, video games-of-chance, video poker machines, roulette machines), electronic table games, electronic table game systems, laptop computers, handheld computers, tablet computers, cellular telephones, video game consoles, mobile electronic devices, and portable electronic devices.

The use of “non-transitory computer-readable media” and “non-transitory computer-readable medium” is intended to be representative of any tangible computer-based device implemented in any method or technology for short-term and long-term storage of information, such as, computer-readable instructions, data structures, program modules and sub-modules, or other data in any device, unless the context clearly dictates otherwise. To wit, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

### DETAILED DESCRIPTION

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

Disclosed herein are gaming systems, gaming devices, and methods of gaming using the concept of over-under from sports gambling.

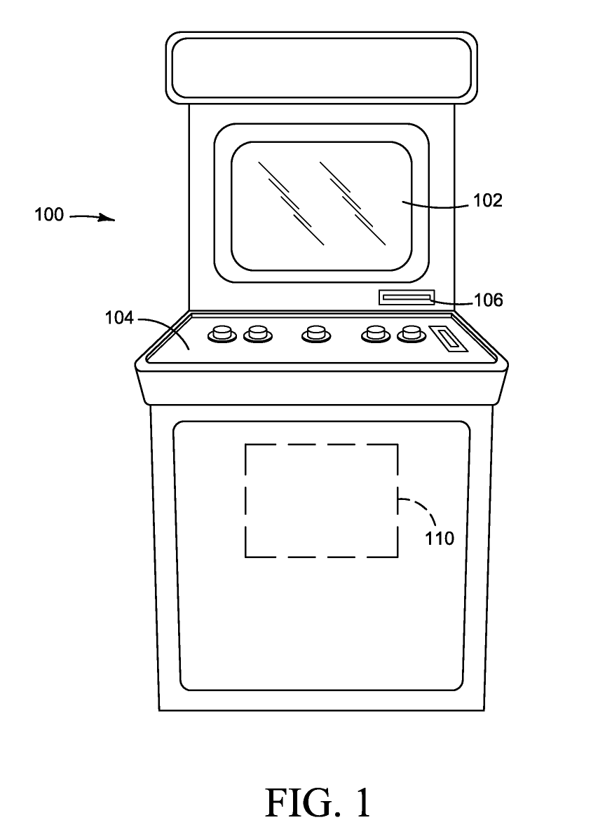

FIG. 1 illustrates a first exemplary gaming machine 100 that may implement the present methods. The gaming machine 100 may include a display 102 that displays one or more hands of playing cards. A player may navigate the playing cards displayed on the display 102 using a button deck 104, through pressing upon the display 102 where the display is a touch-screen display, or through other user input. Any suitable configuration of the buttons on the button deck 104 can be used and, alternatively, conventional touch screen technology can be used for any or all of the buttons mounted on the button deck 104.

The gaming machine 100 further comprising a computer system 110 and/or systems for implementing the various methods disclosed herein.

At the gaming machine 100, a player can input a wager by any known means, such as directing the wagering of existing credits, a coin, token or cash acceptor, wagering from a credit card, debit card, or the like. For instance, a player can enter a primary wager before a round begins. After the player at a gaming machine 100 has entered a primary wager, the computer system 110, from data representing one or more decks of playing cards, controls the display 102 to display for the player a first face up playing card, and two face down playing cards. While that is the dealing arrangement described with respect to the gaming machine 100 illustrated in this figure, a skilled artisan will be able to select an appropriate order and arrangement for the dealing of the playing cards in a particular embodiment based on various considerations. For example, all three playing cards could be dealt face down, and one of the player's three playing cards could thereafter be turned face up; or only the first face up playing card could be initially displayed.

The player is then permitted to enter an over wager, enter an under wager, or fold, all done as user input via a touch screen integrated into the display 102, the button deck 104, etc. The computer system 110 likewise controls the display 102 to display completion of the player's hand by revealing the faces of the two remaining playing cards. The computer system 110 further compares data representing the player's hands to determine if the player won or the house won, and to determine what payout (if any) is due to the player. Winnings are credited to the player's gaming machine 100, and loses are collected by the computer system 110.

The computer system 110 includes a processor and memory in electronic communication with the processor. Instructions are stored in the memory. The instructions are executable to display at least one hand of playing cards on the display. Each hand of playing cards includes one or more playing card positions. A playing card is placed in each of the one or more playing card positions. The player is able to make betting and game selections through user input via button deck 104 and/or a touch-screen display. The instructions are also executable to act on user input. The instructions are also executable to analyze characteristics associated with each playing card in the each hand of playing cards. Further, the instructions are executable to determine a winning combination of playing cards is formed based on the sum of the numerical values of the cards, and provide a payout award based on the winning combination of playing cards.

The gaming machine 100 could comprise a conventional currency/ticket acceptor 106 by which the player can insert currency or tickets to add credits to a credit meter. It is also possible to provide a conventional coin head (not illustrated) to allow the player to add credits or make wagers by using coins or gaming tokens. As is also conventional in electronic video slot/poker machines, the credit meter (not illustrated) is provided to show the amount of credits that the player has accrued on the gaming machine 100, either by inserting coins, tokens, currency or tickets or from winning plays achieved by the player. Whenever the player makes a wager, the amount of the wager is decremented from the credit meter. Whenever the player achieves a winning play during the play of the game, the amount of the winning play is incremented on the credit meter.

A non-transitory computer-readable medium including executable instructions is also disclosed. The instructions are executable to display more than one hand of playing cards. Each hand of playing cards includes one or more playing card positions. A playing card is placed in each of the one or more playing card positions. The player is able to make betting and game selections through user input via button deck and/or a touch-screen display. The instructions are also executable to act on user input. The instructions are also executable to analyze characteristics associated with each playing card in the each hand of playing cards. Further, the instructions are executable to determine a winning combination of playing cards is formed based on the sum of the numerical values of the cards, and provide a payout award based on the winning combination of playing cards.

An electronically implemented method of playing a casino game using images of playing cards could be implemented on such an exemplary gaming machine 100. The exemplary gaming machine 100 could include a non-transitory computer-readable medium coded with instructions executed by a processor to perform a number of steps establishing playing positions on the display screen for at least one player. The exemplary gaming machine 100 could provide electronically producible images of at least one standard deck of fifty-two playing cards with respective faces designated in ascending numerical sum 2-10, J, Q, K, A each in four suits.

The exemplary gaming machine 100 could assign a numerical value to each playing card, where the numerical value is equivalent to the face value for playing cards designated 2-10, said numerical value being ten for playing cards designated J, Q, K, and said numerical value being eleven for playing cards designated A. Such a numerical value scheme being the same as the numerical value scheme in Blackjack except that the Ace always counts as eleven.

The exemplary gaming machine 100 could accept a primary wager from the player, deal the player three playing cards face down, turn one of player's three playing cards face up, and then allow the player to review the first playing card and do one of: (1) place an over wager that the sum of the numerical values of the three playing cards will be more than a first numerical value, (2) place an under wager that the sum of the numerical values of the three playing cards will be less than a second numerical value, or (3) fold. If the player folds, the gaming machine 100 could confiscate the player's primary wager.

Once such supplemental wagers are placed, the player's two remaining playing cards are then turned face up or are otherwise dealt to the player. Based on the sum of the three player cards, the player's primary wager, and the player's over wager or the player's under wager, can be settled.

In one embodiment, settling step includes confiscating the player's primary wager and any over wager or under wager made by the player if the sum of the numerical values is any numerical value greater than or equal to the second numerical value, and less than or equal to the first numerical value, regardless of whether the player placed an over wager or placed an under wager. Further, the settling step could include confiscating the player's primary wager and the player's over wager if the sum of the numerical values is less than or equal to the first numerical value and the player placed an over wager. Further, the settling step could include confiscating the player's primary wager and the player's under wager if the sum of the numerical values is greater than or equal to the second numerical value and the player placed an under wager. Further, the settling step could include paying the player a winning payout associated with the player's primary wager and the player's under wager if the sum of the numerical values is less than the second numerical value and the player placed an under wager. Further, the settling step could include paying the player a winning payout associated with the player's primary wager and the player's over wager if the sum of the numerical values is greater than the first numerical value and the player placed an over wager.

In a preferred embodiment, the first numerical value is “23,” and the second numerical value is “18.” While these are the preferred values in such a preferred embodiment, a skilled artisan will be able to select an appropriate value for the first numerical value and/or the second numerical value in a particular embodiment based on various considerations.

In a second preferred embodiment, the over wager amount is equal to the primary wager amount, and the under wager amount is equal to the primary wager amount.

In a third preferred embodiment, the method further comprises accepting a bonus wager from the player, preferably before the face of the first playing card is revealed. In such an embodiment, the settling step could include confiscating the player's bonus wager if the sum of the numerical values is any numerical value greater than or equal to the second numerical value, and less than or equal to the first numerical value. Further, the settling step could include confiscating the player's bonus wager if the sum of the numerical values is less than or equal to the first numerical value and the player placed an over wager. Further, the settling step could include confiscating the player's bonus wager if the sum of the numerical values is greater than or equal to the second numerical value and the player placed an under wager. Further, the settling step could include paying the player a winning payout associated with the player's bonus wager if the sum of the numerical values is less than the second numerical value and the player placed an under wager. Further, the settling step could include paying the player a winning payout associated with the player's bonus wager if the sum of the numerical values is greater than the first numerical value and the player placed an over wager. In such an embodiment, the first numerical value could be set at “23,” and the second numerical value set at “18.” While these are the preferred values in such a preferred embodiment, a skilled artisan will be able to select an appropriate value for the first numerical value and/or the second numerical value in a particular embodiment based on various considerations. Further, in such an embodiment, the over wager amount could be set equal to the primary wager amount, and the under wager amount could be set equal to the primary wager amount. Optionally, the bonus wager could not be confiscated before the second and third cards are revealed, and the bonus wager could be settled based upon the sum of the numerical value of the cards.

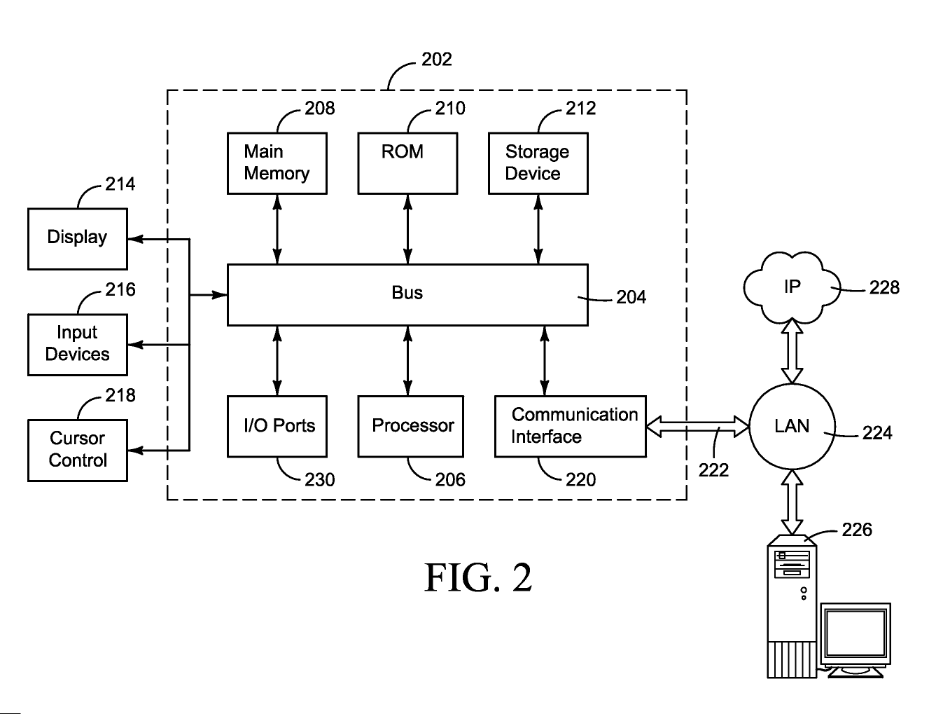

FIG. 2 illustrates a computer system 202 upon which the methods disclosed herein may be implemented. The computer system 202 may be any one of a personal computer system, a work station computer system, a laptop computer system, an embedded controller system, a microprocessor-based system, a digital signal processor-based system, a hand held device system, a personal digital assistant (PDA) system, a wireless system, a wireless networking system, etc.

The computer system 202 includes a bus 204 or other communication mechanism for communicating information, and a processor 206 coupled with bus 204 for processing the information. The computer system 202 also includes a main memory 208, such as a random access memory (RAM) or other dynamic storage device (e.g., dynamic RAM (DRAM), static RAM (SRAM), synchronous DRAM (SDRAM), flash RAM), coupled to bus 204 for storing information and instructions to be executed by processor 206. In addition, main memory 208 may be used for storing temporary variables or other intermediate information during execution of instructions to be executed by processor 206. Computer system 202 further includes a read only memory (ROM) 210 or other static storage device (e.g., programmable ROM (PROM), erasable PROM (EPROM), and electrically erasable PROM (EEPROM)) coupled to bus 204 for storing static information and instructions for processor 206. A storage device 212, such as a magnetic disk or optical disk, may be provided and coupled to bus 204 for storing information and instructions.

The computer system 202 also includes input/output ports 230 to couple the computer system 202 to external devices. Such coupling may include direct electrical connections, wireless connections, networked connections, etc., for implementing automatic control functions, remote control functions, etc.

The computer system 202 may also include special purpose logic devices (e.g., application specific integrated circuits (ASICs)) or configurable logic devices (e.g., generic array of logic (GAL) or re-programmable field programmable gate arrays (FPGAs)). Other removable media devices (e.g., a compact disc, a tape, and a removable magneto-optical media) or fixed, high-density media drives, may be added to the computer system 202 using an appropriate device bus (e.g., a small computer system interface (SCSI) bus, an enhanced integrated device electronics (IDE) bus, or an ultra-direct memory access (DMA) bus). The computer system 202 may additionally include a compact disc reader, a compact disc reader-writer unit, or a compact disc jukebox, each of which may be connected to the same device bus or another device bus.

The computer system 202 may be coupled via bus 204 to a display 214 (e.g., liquid crystal display (LCD), light emitting diode (LED) display, voice synthesis hardware, voice synthesis software) for displaying and/or providing information to a computer user. The display 214 may be controlled by a display or graphics card.

The computer system 202 includes input devices, such as a keyboard 216 (e.g., a button deck) and a cursor control 218, for communicating information and command selections to processor 206. Such command selections can be implemented via software functioning as the input devices (keyboard) 216. The cursor control 218, for example, is a mouse, a trackball, cursor direction keys, touch screen display, optical character recognition hardware and/or software, etc., for communicating direction information and command selections to processor 206 and for controlling cursor movement on the display 214.

The computer system 202 performs a portion or all of the processing steps of the invention in response to processor 206 executing one or more sequences of one or more instructions contained in a memory, such as the main memory 208. Such instructions may be read into the main memory 208 from another computer-readable medium, such as storage device 212. One or more processors in a multi-processing arrangement may also be employed to execute the sequences of instructions contained in main memory 208. In alternative embodiments, hard-wired circuitry may be used in place of or in combination with software instructions. Thus, embodiments are not limited to any specific combination of hardware circuitry and software.

As stated above, the computer system 202 includes at least one non-transitory computer-readable medium or memory programmed according to the teachings of the invention and for containing data structures, tables, records, or other data described herein. Examples of computer-readable media are compact discs, hard disks, floppy disks, tape, magneto-optical disks, PROMs (EPROM, EEPROM, Flash EPROM), DRAM, SRAM, SDRAM, etc. Stored on any one or on a combination of computer-readable media, the present invention includes software for controlling the computer system 202, for driving a device or devices for implementing the invention, and for enabling the computer system 202 to interact with a human user. Such software may include, but is not limited to, device drivers, operating systems, development tools, and applications software. Such computer-readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, and complete executable programs. Moreover, parts of the processing of the present invention may be distributed for better performance, reliability, and/or cost.

Computer-readable medium participates in providing instructions to processor 206 for execution. A computer-readable medium may take many forms, including but not limited to, non-volatile media, volatile media, and transmission media. Non-volatile media includes, for example, optical, magnetic disks, and magneto-optical disks, such as storage device 212. Volatile media includes dynamic memory, such as main memory 208. Transmission media includes coaxial cables, copper wire and fiber optics, including the wires that comprise bus 204. Transmission media also may also take the form of acoustic or light waves, such as those generated during radio wave and infrared data communications. Common forms of computer-readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read. Various forms of computer-readable media may be involved in carrying out one or more sequences of one or more instructions to processor 206 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 202 may receive the data on the telephone line and use an infrared transmitter to convert the data to an infrared signal. An infrared detector coupled to bus 204 can receive the data carried in the infrared signal and place the data on bus 204. The bus 204 carries the data to main memory 208, from which processor 206 retrieves and executes the instructions. The instructions received by main memory 208 may optionally be stored on storage device 212 either before or after execution by processor 206.

The computer system 202 also includes a communication interface 220 coupled to bus 204. Communication interface 220 provides a two-way data communication coupling to a network link 222 that may be connected to, for example, a local network 224. For example, communication interface 220 may be a network interface card to attach to any packet switched local area network (LAN). As another example, communication interface 220 may be an asymmetrical digital subscriber line (ADSL) card, an integrated services digital network (ISDN) card or a modem to provide a data communication connection to a corresponding type of telephone line. Wireless links may also be implemented via the communication interface 220. In any such implementation, communication interface 220 sends and receives electrical, electromagnetic or optical signals that carry digital data streams representing various types of information.

Network link 222 typically provides data communication through one or more networks to other data devices. For example, network link 222 may provide a connection to a computer 226 through local network 224 (e.g., a LAN) or through equipment operated by a service provider, which provides communication services through a communications network 228. In preferred embodiments, local network 224 and communications network 228 preferably use electrical, electromagnetic, or optical signals that carry digital data streams. The signals through the various networks and the signals on network link 222 and through communication interface 220, which carry the digital data to and from computer system 202, are exemplary forms of carrier waves transporting the information. The computer system 202 can transmit notifications and receive data, including program code, through the network(s), network link 222 and communication interface 220.

FIG. 2 illustrates only one possible configuration of a computer system 202. Various other architectures and components may be utilized.

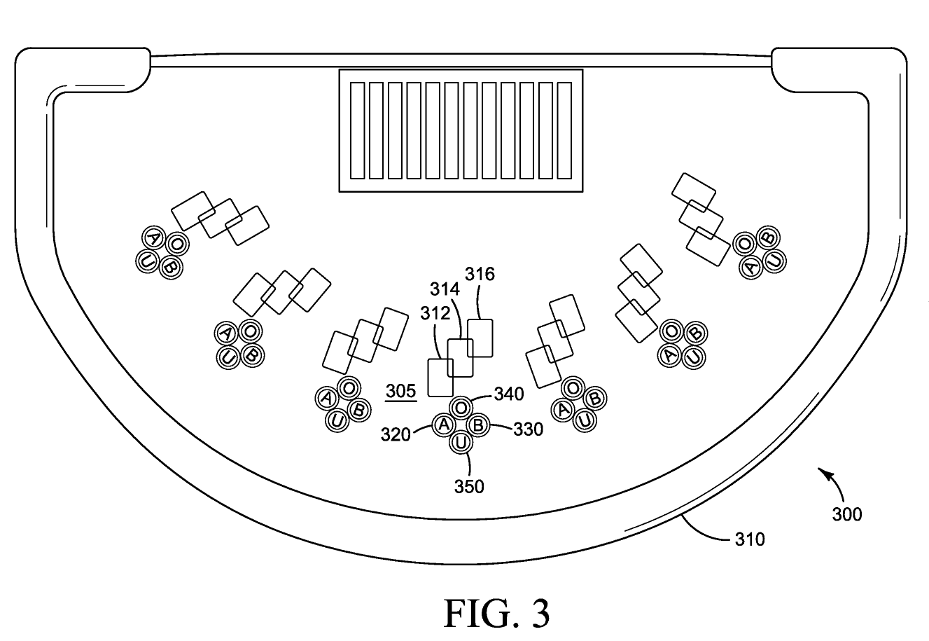

FIG. 3 is a drawing illustrating an exemplary table layout, according to an exemplary method of playing a casino table game using playing cards. The layout illustrated in FIG. 3 seven simultaneous players, although of course other layouts can accommodate any reasonable number of players.

The exemplary method could utilize at least one standard deck of fifty-two playing cards with respective faces designated in ascending numerical sum 2-10, J, Q, K, A each in four suits. A numerical value is assigned to each playing card, the numerical value being equivalent to the face value for playing cards designated 2-10, the numerical value being ten for playing cards designated J, Q, K, and the numerical value being eleven for playing cards designated. While this numerical value scheme is preferred, a skilled artisan will be able to select an appropriate numerical value scheme in a particular embodiment based on various considerations. The playing cards could be held in, and dealt from, a shoe.

During a round of play, a primary wager is accepted from the player and placed on the betting field 305 of a table 310 in primary wager circle 320. Primary wager circle 320 is labeled in this Figure with an “A” for “ante.” Optionally, the player could make a bonus wager by placing the wager on the betting field 305 in the bonus wager circle 330. Bonus wager circle 330 is labeled in this Figure with a “B” for “bonus.” Preferably, the optional bonus wager does not exceed the amount of the primary wager.

During the course of a round of play, three playing cards are dealt to the player, preferably by a dealer. In the exemplary method illustrated in FIG. 3, a first playing card is dealt face up into position 312. Upon viewing the face up playing card dealt into position 312, the player is allowed to do one of: (1) place an over wager (a raise wager) that the sum of the numerical values of the first playing card and the two additional playing cards will be more than a first numerical value, (2) place an under wager (a raise wager) that the sum of the numerical values of the first playing card and the two additional playing cards will be less than a second numerical value, or (3) fold.

To place an over wager, the player could place the wager on the betting field 305 within the over wager circle 340. Over wager circle 340 is labeled in this Figure with an “O” for “over.” To place an under wager, the player could place the wager on the betting field 305 within the under wager circle 350. Under wager circle 350 is labeled in this Figure with a “U” for “under.” It is preferred that the amount of the over wager and the under wager be equal to the primary wager. However, in other exemplary gaming systems, gaming devices, and methods of gaming, such a limitation may not be present.

To fold, the player could indicate to the dealer the same, and the player's primary wager could be confiscated by the dealer.

Once the player's post-first playing card reveal actions have been undertaken, and all side betting (over/under, bonus) is closed, a second playing card is dealt face up into position 314, and a third playing card is dealt face up into position 316.

A skilled artisan will be able to select an appropriate order and arrangement, including face up/face down, for the dealing of the playing cards in a particular embodiment based on various considerations. For example, all three playing cards could be dealt face down, and one of the player's three playing cards could thereafter be turned face up; instead of the first playing card being dealt face up, then accepting side wager, then dealing the remaining two cards, all three cards could be dealt before the side wagers are accepted; and instead of the player making the primary wager, and optional bonus wager, before the playing cards are dealt, the playing cards could be dealt before such wagers are made (but before the first playing card is turned face up).

In an alternative embodiment, the second and third playing cards are not dealt to players, but are dealt as community playing cards upon which the players wager. In another alternative embodiment, all three playing cards could be dealt as community playing cards upon which the players wager.

Upon revealing the player's three cards, the player's wagers are settled dependent upon the sum of the numerical values of the player's three playing cards.

If the sum of the numerical values is any numerical value greater than or equal to the second numerical value, and less than or equal to the first numerical value, then sum is neither over or under and the house wins. In such a situation, the dealer confiscates all wagers made by the player, including the player's primary wager, any over wager, any under wager, and any optional bonus wager made by the player. Optionally, the bonus wager could not be confiscated before the second and third cards are revealed, and the bonus wager could be settled based upon the sum of the numerical value of the cards.

If the sum of the numerical values is less than or equal to the first numerical value and the player placed an over wager, then the house wins. In such a situation, the dealer confiscates the player's primary wager, the player's over wager, and any optional bonus wager made by the player. Optionally, the bonus wager could not be confiscated before the second and third cards are revealed, and the bonus wager could be settled based upon the sum of the numerical value of the cards.

If the sum of the numerical values is greater than or equal to the second numerical value and the player placed an under wager, then the house wins. In such a situation, the dealer confiscates the player's primary wager, the player's under wager, and any optional bonus wager made by the player. Optionally, the bonus wager could not be confiscated before the second and third cards are revealed, and the bonus wager could be settled based upon the sum of the numerical value of the cards.

If the sum of the numerical values is less than the second numerical value and the player placed an under wager, then the player wins. In such a situation, the player is paid a winning payout associated with the player's primary wager, the player's under wager, and any optional bonus wager made by the player.

If the sum of the numerical values is greater than the first numerical value and the player placed an over wager, then the player wins. In such a situation, the player is paid a winning payout associated with the player's primary wager, the player's over wager, and any optional bonus wager made by the player.

Preferably, where the player is paid a winning payout associated with the player's primary wager, over wager, and under wager, the payout is equal to the wager made.

The bonus wager payout could be made according to a pay table. Examples of a first exemplary pay table and a second exemplary pay table can be found in Table A and Table B.

TABLE A
Bonus Pay Table

| Total | Odds |
|---|---|
| 6 or 33 | 50 to 1 |
| 7 or 32 | 10 to 1 |
| 8 or 31 | 5 to 1 |
| 9 or 30 | 4 to 1 |
| 10 or 29 | 3 to 1 |
| 11 or 28 | 2 to 1 |
| 12 or 27 | 1 to 1 |
| 13 through 26 | Loss |

TABLE B
Bonus Pay Table

| Total | Odds |
|---|---|
| 6 or 33 | 50 to 1 |
| 7 | 30 to 1 |
| 8 | 20 to 1 |
| 9 | 15 to 1 |
| 32 | 10 to 1 |
| 10 | 5 to 1 |
| 11 | 4 to 1 |
| 12 | 3 to 1 |
| 31 | 2 to 1 |
| 13 | 1 to 1 |
| 26 through 30 | 1 to 1 |
| 12 through 25 | Loss |

These pay tables are merely examples, and a skilled artisan will be able to select an appropriate pay table for the bonus wager in a particular embodiment based on various considerations.

Optionally, if the sum of the numerical values is equal to the first numerical value, then a push exists, and the player's primary wager is returned to the player.

Optionally, if the sum of the numerical values is equal to the second numerical value, then a push exists, and the player's primary wager is returned to the player.

Optionally, the bonus wager could not be confiscated before the second and third cards are revealed, and the bonus wager could be settled based upon the sum of the numerical value of the cards.

The first numerical value is preferably “23,” and the second numerical value is preferably “18.” While those are the preferred numerical values used in exemplary gaming systems, gaming devices, and methods of gaming, a skilled artisan will be able to select an appropriate first and second numerical value in a particular embodiment based on various considerations, including changing the house advantage for the game.

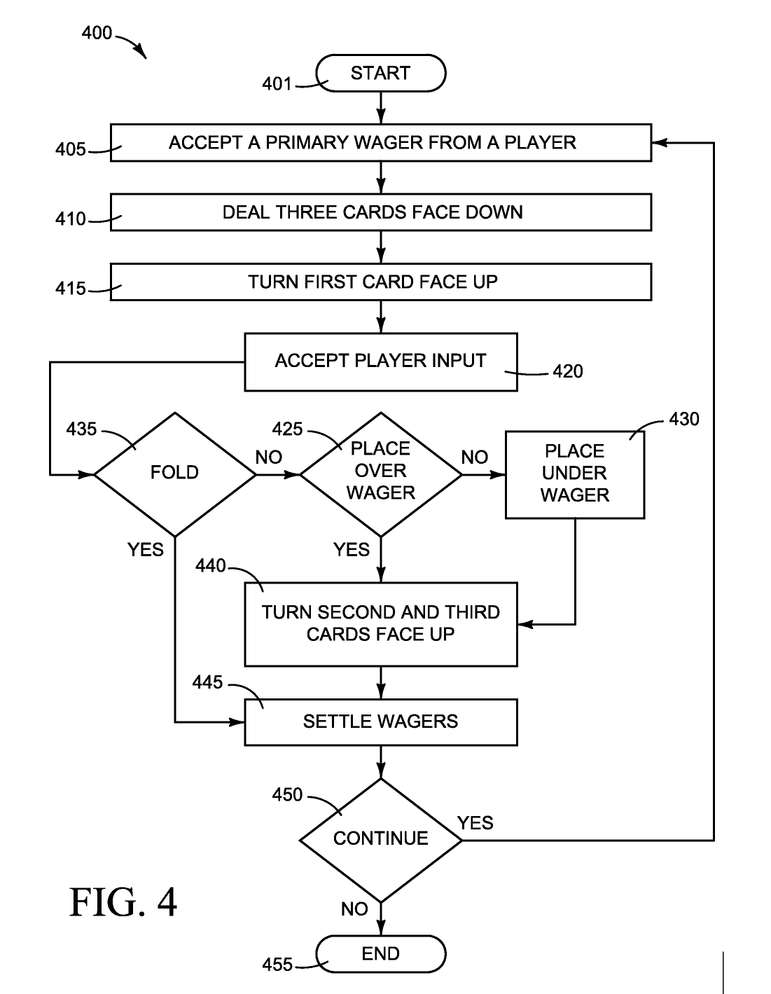

FIG. 4 illustrates a method 400 according a preferred embodiment of the invention. The process begins at step 401. At step 405, a primary wager or “ante” is accepted from a player. At step 410, three playing cards are dealt to the player. At step 415, a first one of the three playing cards is turned face up. While such a dealing scheme is defined with respect to this embodiment, a skilled artisan will be able to select an appropriate order and arrangement for the dealing of the playing cards in a particular embodiment based on various considerations. For example, all three playing cards could be dealt face down, and one of the player's three playing cards could thereafter be turned face up; the playing cards could be dealt one at a time; etc.

At step 420, upon viewing the value of the face up playing card, the player can make a decision regarding how to proceed, and can provide input accordingly. At step 425, the player can place an over wager that the sum of the numerical values of the three playing cards will be more than a first numerical value. At step 430, the player can place an under wager that the sum of the numerical values of the three playing cards will be less than a second numerical value. At step 435, the player can decide to fold without making any additional wagers. If, at step 425 or 430 the player decided to place an over wager or an under wager, then play would progress to step 440. At step 440, the player's two remaining playing cards would be turned face up, and play would progress to step 445. If, at step 435, the player decided to fold, then play would progress to step 445. In step 445, because the player folded, the player's primary wager would be confiscated by the house, and the player would be able to decide (step 450) whether to proceed with another round of play (the process returning to step 405), or end the player's game (step 445). If, at step 425 or step 435, the player place an over wager or an under wager, then at step 445 the player's wagers would be settled dependent upon the sum of the numerical values of the player's three playing cards.

If the sum of the numerical values is any numerical value greater than or equal to the second numerical value, and less than or equal to the first numerical value, then sum is neither over or under and the house wins. In such a situation, the dealer would confiscate all wagers made by the player, including the player's primary wager, and the over wager or under wager made by the player.

If the sum of the numerical values is less than or equal to the first numerical value and the player placed an over wager, then the house wins. In such a situation, the dealer would confiscate the player's primary wager and the over wager made by the player.

If the sum of the numerical values is greater than or equal to the second numerical value and the player placed an under wager, then the house wins. In such a situation, the dealer would confiscate the player's primary wager and the under wager made by the player.

If the sum of the numerical values is less than the second numerical value and the player placed an under wager, then the player wins. In such a situation, the player is paid a winning payout associated with the player's primary wager, and the player's under wager.

If the sum of the numerical values is greater than the first numerical value and the player placed an over wager, then the player wins. In such a situation, the player is paid a winning payout associated with the player's primary wager and the player's over wager.

Upon settling the wagers in step 445, the player would be able to decide (step 450) whether to proceed with another round of play (the process returning to step 405), or end the player's game (step 445). In step 455, the process ends.

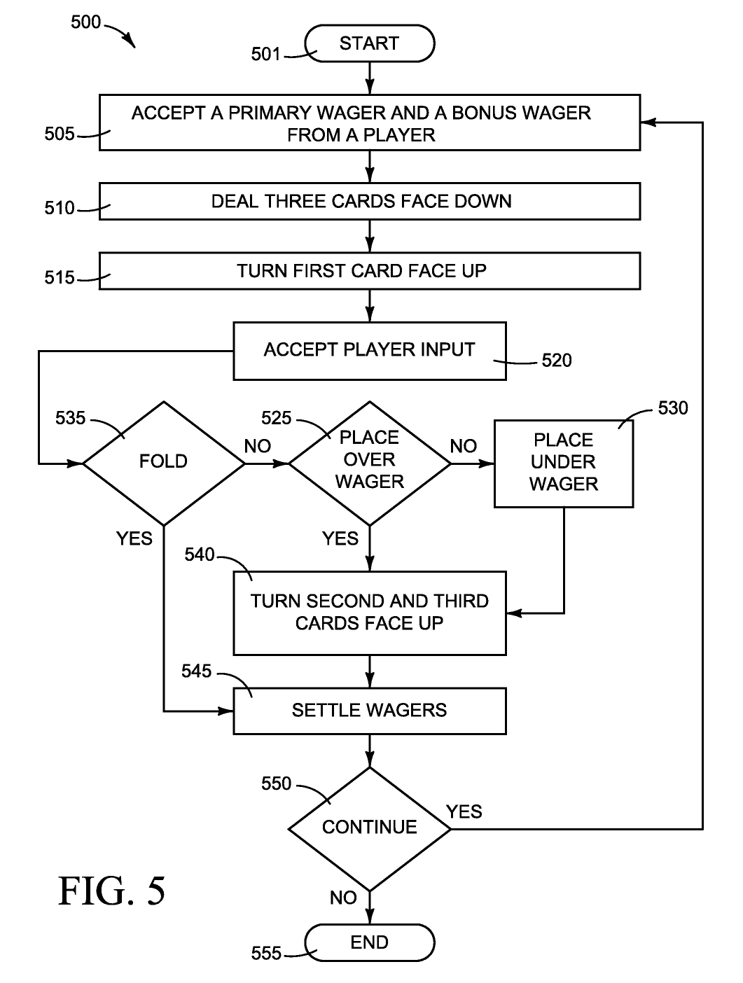

FIG. 5 illustrates a second method according a preferred embodiment of the invention. The process begins at step 501. At step 505, a primary wager or “ante” is accepted from a player, and a bonus wager is accepted from the player. At step 510, three playing cards are dealt to the player. At step 515, a first one of the three playing cards is turned face up. While such a dealing scheme is defined with respect to this embodiment, a skilled artisan will be able to select an appropriate order and arrangement for the dealing of the playing cards in a particular embodiment based on various considerations. For example, all three playing cards could be dealt face down, and one of the player's three playing cards could thereafter be turned face up.

At step 520, upon viewing the value of the face up playing card, the player can make a decision regarding how to proceed, and can provide input accordingly. At step 525, the player can place an over wager that the sum of the numerical values of the three playing cards will be more than a first numerical value. At step 530, the player can place an under wager that the sum of the numerical values of the three playing cards will be less than a second numerical value. At step 535, the player can decide to fold without making any additional wagers. If, at step 525 or 530 the player decided to place an over wager or an under wager, then play would progress to step 540. At step 540, the player's two remaining playing cards would be turned face up, and play would progress to step 545. If, at step 535, the player decided to fold, then play would progress to step 545. In step 545, because the player folded, the player's primary wager and any bonus wager made would be confiscated by the house, and the player would be able to decide (step 550) whether to proceed with another round of play (the process returning to step 505), or end the player's game (step 545). Optionally, the bonus wager could not be confiscated before the second and third cards are revealed, and the bonus wager could be settled based upon the sum of the numerical value of the cards. If, at step 525 or step 535, the player place an over wager or an under wager, then at step 545 the player's wagers would be settled dependent upon the sum of the numerical values of the player's three playing cards.

If the sum of the numerical values is any numerical value greater than or equal to the second numerical value, and less than or equal to the first numerical value, then sum is neither over or under and the house wins. In such a situation, the dealer would confiscate all wagers made by the player, including the player's primary wager, the over wager or under wager made by the player, and any bonus wager made by the player. Optionally, the bonus wager could not be confiscated before the second and third cards are revealed, and the bonus wager could be settled based upon the sum of the numerical value of the cards.

If the sum of the numerical values is less than or equal to the first numerical value and the player placed an over wager, then the house wins. In such a situation, the dealer would confiscate the player's primary wager, the over wager made by the player, and any bonus wager made by the player. Optionally, the bonus wager could not be confiscated before the second and third cards are revealed, and the bonus wager could be settled based upon the sum of the numerical value of the cards.

If the sum of the numerical values is greater than or equal to the second numerical value and the player placed an under wager, then the house wins. In such a situation, the dealer would confiscate the player's primary wager, the under wager made by the player, and any bonus wager made by the player. Optionally, the bonus wager could not be confiscated before the second and third cards are revealed, and the bonus wager could be settled based upon the sum of the numerical value of the cards.

If the sum of the numerical values is less than the second numerical value and the player placed an under wager, then the player wins. In such a situation, the player is paid a winning payout associated with the player's primary wager, the player's under wager, and the player's bonus wager.

If the sum of the numerical values is greater than the first numerical value and the player placed an over wager, then the player wins. In such a situation, the player is paid a winning payout associated with the player's primary wager, the player's over wager, and the player's bonus wager.

Upon settling the wagers in step 545, the player would be able to decide (step 550) whether to proceed with another round of play (the process returning to step 505), or end the player's game (step 545). In step 555, the process ends.

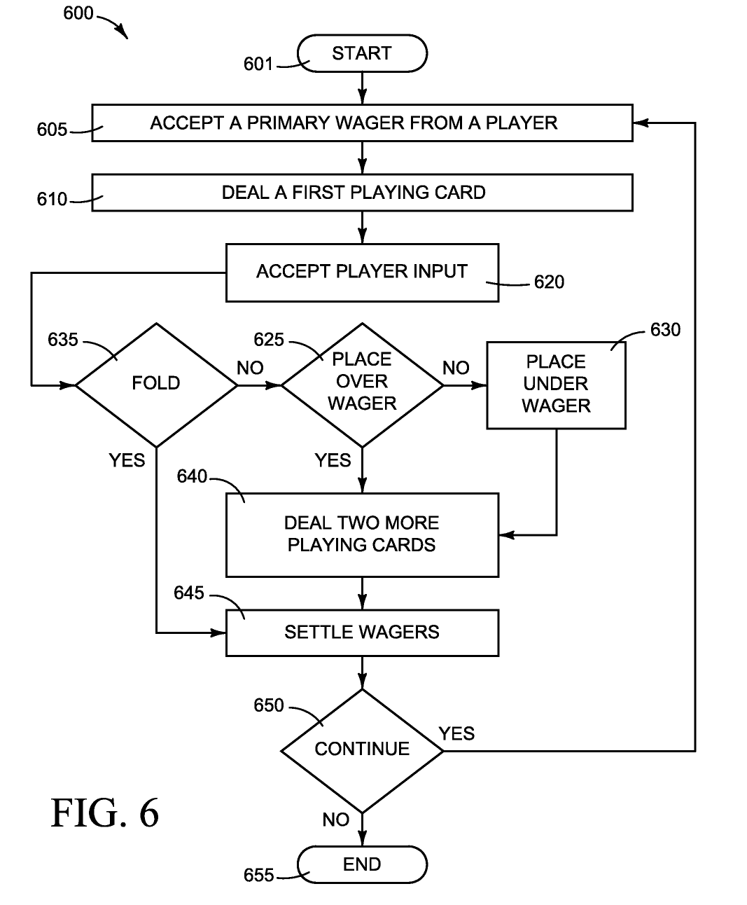

FIG. 6 illustrates a method 600 according a preferred embodiment of the invention. The process begins at step 601. At step 605, a primary wager or “ante” is accepted from a player. At step 610, a first playing card is dealt to the player. At step 620, the player can make a decision regarding how to proceed, and can provide input accordingly. At step 625, the player can place an over wager that the sum of the numerical values of the first playing card and the two additional playing cards will be more than a first numerical value. At step 630, the player can place an under wager that the sum of the numerical values of the first playing card and the two additional playing cards will be less than a second numerical value. At step 635, the player can decide to fold without making any additional wagers. If, at step 625 or 630 the player decided to place an over wager or an under wager, then play would progress to step 640. At step 640, the two additional playing cards would be dealt to the player, and play would progress to step 645. If, at step 635, the player decided to fold, then play would progress to step 645. In step 645, because the player folded, the player's primary wager would be confiscated by the house, and the player would be able to decide (step 650) whether to proceed with another round of play (the process returning to step 605), or end the player's game (step 645). If, at step 625 or step 635, the player place an over wager or an under wager, then at step 645 the player's wagers would be settled dependent upon the sum of the numerical values of the player's three playing cards.

If the sum of the numerical values is any numerical value greater than or equal to the second numerical value, and less than or equal to the first numerical value, then sum is neither over or under and the house wins. In such a situation, the dealer would confiscate all wagers made by the player, including the player's primary wager, and the over wager or under wager made by the player.

If the sum of the numerical values is less than or equal to the first numerical value and the player placed an over wager, then the house wins. In such a situation, the dealer would confiscate the player's primary wager and the over wager made by the player.

If the sum of the numerical values is greater than or equal to the second numerical value and the player placed an under wager, then the house wins. In such a situation, the dealer would confiscate the player's primary wager and the under wager made by the player.

If the sum of the numerical values is less than the second numerical value and the player placed an under wager, then the player wins. In such a situation, the player is paid a winning payout associated with the player's primary wager, and the player's under wager.

If the sum of the numerical values is greater than the first numerical value and the player placed an over wager, then the player wins. In such a situation, the player is paid a winning payout associated with the player's primary wager and the player's over wager.

Upon settling the wagers in step 645, the player would be able to decide (step 650) whether to proceed with another round of play (the process returning to step 605), or end the player's game (step 645). In step 655, the process ends.

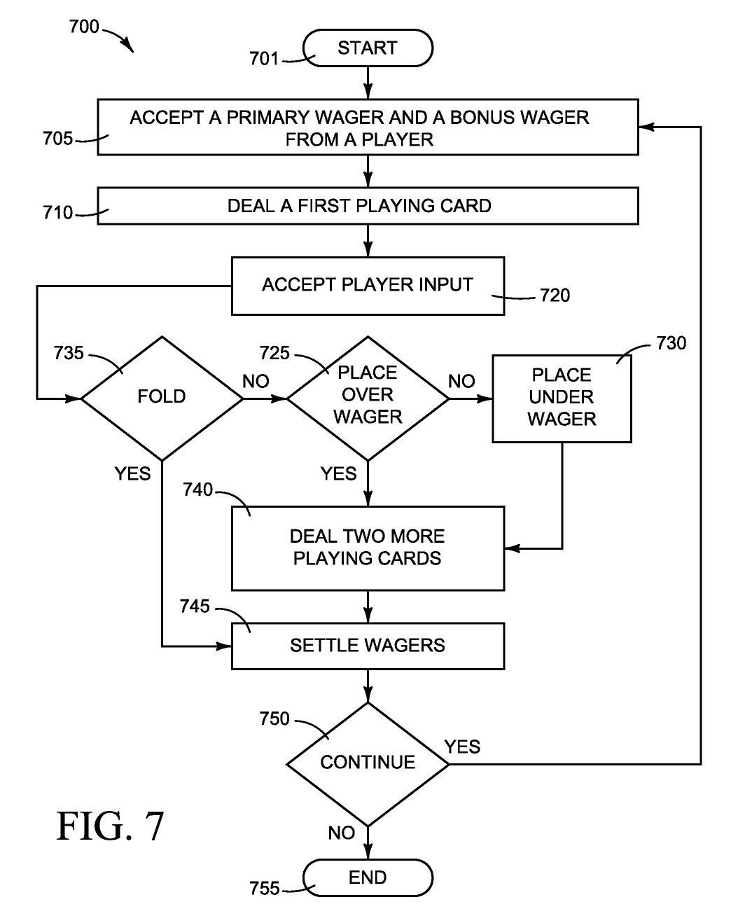

FIG. 7 illustrates a method 700 according a preferred embodiment of the invention. The process begins at step 701. At step 705, a primary wager or “ante” is accepted from a player, as is an optional bonus wager. At step 710, a first playing card is dealt to the player. At step 720, the player can make a decision regarding how to proceed, and can provide input accordingly. At step 725, the player can place an over wager that the sum of the numerical values of the first playing card and the two additional playing cards will be more than a first numerical value. At step 730, the player can place an under wager that the sum of the numerical values of the first playing card and the two additional playing cards will be less than a second numerical value. At step 735, the player can decide to fold without making any additional wagers. If, at step 725 or 730 the player decided to place an over wager or an under wager, then play would progress to step 740. At step 740, the two additional playing cards would be dealt to the player, and play would progress to step 745. If, at step 735, the player decided to fold, then play would progress to step 745. In step 745, because the player folded, the player's primary wager would be confiscated by the house, and the player would be able to decide (step 750) whether to proceed with another round of play (the process returning to step 705), or end the player's game (step 745). If, at step 725 or step 735, the player place an over wager or an under wager, then at step 745 the player's wagers would be settled dependent upon the sum of the numerical values of the player's three playing cards.

If the sum of the numerical values is any numerical value greater than or equal to the second numerical value, and less than or equal to the first numerical value, then sum is neither over or under and the house wins. In such a situation, the dealer would confiscate all wagers made by the player, including the player's primary wager, the over wager or under wager made by the player, and any bonus wager made. Optionally, the bonus wager could not be confiscated before the second and third cards are revealed, and the bonus wager could be settled based upon the sum of the numerical value of the cards.

If the sum of the numerical values is less than or equal to the first numerical value and the player placed an over wager, then the house wins. In such a situation, the dealer would confiscate the player's primary wager, the over wager made by the player, and any bonus wager made. Optionally, the bonus wager could not be confiscated before the second and third cards are revealed, and the bonus wager could be settled based upon the sum of the numerical value of the cards.

If the sum of the numerical values is greater than or equal to the second numerical value and the player placed an under wager, then the house wins. In such a situation, the dealer would confiscate the player's primary wager, the under wager made by the player, and any bonus wager made. Optionally, the bonus wager could not be confiscated before the second and third cards are revealed, and the bonus wager could be settled based upon the sum of the numerical value of the cards.

If the sum of the numerical values is less than the second numerical value and the player placed an under wager, then the player wins. In such a situation, the player is paid a winning payout associated with the player's primary wager, the player's under wager, and any bonus wager made.

If the sum of the numerical values is greater than the first numerical value and the player placed an over wager, then the player wins. In such a situation, the player is paid a winning payout associated with the player's primary wager, the player's over wager, and any bonus wager made.

Upon settling the wagers in step 745, the player would be able to decide (step 750) whether to proceed with another round of play (the process returning to step 705), or end the player's game (step 745). In step 755, the process ends.

It should be understood that the game described herein may be played, for example, live (in person) at a table, live (in person) at a gaming machine, in electronic format over the Internet, in electric format via a mobile device application, etc.

It is noted that all structure and features of the various described and illustrated embodiments can be combined in any suitable configuration for inclusion in a gaming systems, gaming device, and/or method of gaming according to a particular embodiment.

While the exemplary gaming system, gaming device, and/or method of gaming described herein utilize three playing cards, a skilled artisan will be able to select an appropriate number of playing cards in a particular embodiment based on various considerations.

While the exemplary gaming system, gaming device, and/or method of gaming described herein includes the player placing an over wager or an under wager, in an alternative embodiment, “over or under” wager could be utilized instead, or the player could be limited to only placing an over wager, or only placing an under wager.

In addition to being played in a physical casino table, the methods described herein can also be played on an electronic gaming device or on a computer using the Internet.

The descriptions provided herein also include any hardware and/or software known in the art and needed to implement the operations described herein. Further, all methods described herein can be programmed on a digital computer and stored on any type of computer-readable storage medium.

The methods disclosed herein comprise one or more steps or actions for achieving the described method. The method steps and/or actions may be interchanged with one another without departing from the scope of the claims. In other words, unless a specific order of steps or actions is required for proper operation of the embodiment that is being described, the order and/or use of specific steps and/or actions may be modified without departing from the scope of the claims.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. An electronically implemented method of playing a casino game using images of playing cards, comprising:
providing an electronic gaming machine including at least one display screen configured to display images of playing cards;
the electronic gaming machine including a non-transitory computer-readable medium coded with instructions executed by a processor to perform the steps of:
establishing playing positions on the display screen for at least one player;
providing electronically producible images of at least one standard deck of fifty-two playing cards with respective faces designated in ascending numerical sum 2-10, J, Q, K, A each in four suits;
assigning a numerical value to each playing card, said numerical value being equivalent to the face value for playing cards designated 2-10, said numerical value being ten for playing cards designated J, Q, K, and said numerical value being eleven for playing cards designated A;
accepting a primary wager from a player;
dealing the player a first playing card;
allowing the player to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold, said allowing step including confiscating the player's primary wager if the player folds;
dealing the player said two additional playing cards; and
settling the player's primary wager, and the player's over wager or the player's under wager, dependent upon the sum of the numerical values of the player's three playing cards and whether the player placed an over wager or an under wager.

2. The method of claim 1, wherein:
said settling step including confiscating the player's primary wager and any over wager or under wager made by the player if the sum of the numerical values is any numerical value greater than or equal to the second numerical value, and less than or equal to the first numerical value, regardless of whether the player placed an over wager or placed an under wager;
said settling step including confiscating the player's primary wager and the player's over wager if the sum of the numerical values is less than or equal to the first numerical value and the player placed an over wager;
said settling step including confiscating the player's primary wager and the player's under wager if the sum of the numerical values is greater than or equal to the second numerical value and the player placed an under wager;
said settling step including paying the player a winning payout associated with the player's primary wager and the player's under wager if the sum of the numerical values is less than the second numerical value and the player placed an under wager; and
said settling step including paying the player a winning payout associated with the player's primary wager and the player's over wager if the sum of the numerical values is greater than the first numerical value and the player placed an over wager.

3. The method of claim 1, wherein the first numerical value is 23, wherein the second numerical value is 18.

4. The method of claim 1, wherein the over wager is equal to said primary wager, and wherein the under wager is equal to said primary wager.

5. The method of claim 1, further comprising accepting a bonus wager from the player.

6. The method of claim 1, wherein:
said settling step including confiscating the player's bonus wager if the sum of the numerical values is any numerical value greater than or equal to the second numerical value, and less than or equal to the first numerical value;
said settling step including confiscating the player's bonus wager if the sum of the numerical values is less than or equal to the first numerical value and the player placed an over wager;
said settling step including confiscating the player's bonus wager if the sum of the numerical values is greater than or equal to the second numerical value and the player placed an under wager;
said settling step including paying the player a winning payout associated with the player's bonus wager if the sum of the numerical values is less than the second numerical value and the player placed an under wager; and
said settling step including paying the player a winning payout associated with the player's bonus wager if the sum of the numerical values is greater than the first numerical value and the player placed an over wager.

7. The method of claim 6, wherein the first numerical value is 23, and wherein the second numerical value is 18.

8. The method of claim 6, wherein the over wager is equal to said primary wager, and wherein the under wager is equal to said primary wager.

9. The method of claim 1, wherein said settling step includes settling the bonus wager based upon bonus payout table.

10. An electronically implemented method of playing a casino game using images of playing cards, comprising:
providing an electronic gaming machine including at least one display screen configured to display images of playing cards;
the electronic gaming machine including a non-transitory computer-readable medium coded with instructions executed by a processor to perform the steps of:
establishing playing positions on the display screen for at least one player;
providing at least one standard deck of fifty-two playing cards with respective faces designated in ascending numerical sum 2-10, J, Q, K, A each in four suits;
assigning a numerical value to each playing card, said numerical value being equivalent to the face value for playing cards designated 2-10, said numerical value being ten for playing cards designated J, Q, K, and said numerical value being eleven for playing cards designated A;
accepting a primary wager from the player;
accepting a bonus wager from the player;
dealing the player a first playing card;
allowing the player to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold, said allowing step including confiscating the player's primary wager if the player folds, wherein the first numerical value is 23, wherein the second numerical value is 18;
dealing the player said two additional playing cards; and
settling the player's primary wager, and the player's over wager or the player's under wager, dependent upon the sum of the numerical values of the player's three playing cards.

11. The method of claim 10, wherein:
said settling step including confiscating the player's primary wager, and any over wager or under wager made by the player if the sum of the numerical values is any numerical value greater than or equal to the second numerical value, and less than or equal to the first numerical value, regardless of whether the player placed an over wager or placed an under wager;
said settling step including confiscating the player's primary wager, and the player's over wager if the sum of the numerical values is less than or equal to the first numerical value and the player placed an over wager;
said settling step including confiscating the player's primary wager, and the player's under wager if the sum of the numerical values is greater than or equal to the second numerical value and the player placed an under wager;
said settling step including paying the player a winning payout associated with the player's primary wager, any bonus wager made by the player, and the player's under wager if the sum of the numerical values is less than the second numerical value and the player placed an under wager; and
said settling step including paying the player a winning payout associated with the player's primary wager, any bonus wager made by the player, and the player's over wager if the sum of the numerical values is greater than the first numerical value and the player placed an over wager.

12. The method of claim 10, wherein the over wager is equal to said primary wager, and wherein the under wager is equal to said primary wager.

13. The method of claim 10, wherein said settling step includes settling the bonus wager based upon bonus payout table.

14. The method of claim 10, wherein said settling step includes confiscating any bonus wager made by the player if the sum of the numerical values is any numerical value greater than or equal to the second numerical value, and less than or equal to the first numerical value;
said settling step including confiscating any bonus wager made by the player if the sum of the numerical values is less than or equal to the first numerical value and the player placed an over wager; and
said settling step including confiscating any bonus wager made by the player if the sum of the numerical values is greater than or equal to the second numerical value and the player placed an under wager.

15. A method of playing a casino table game using playing cards, comprising:
providing at least one standard deck of fifty-two playing cards with respective faces designated in ascending numerical sum 2-10, J, Q, K, A each in four suits;
assigning a numerical value to each playing card, said numerical value being equivalent to the face value for playing cards designated 2-10, said numerical value being ten for playing cards designated J, Q, K, and said numerical value being eleven for playing cards designated A;
accepting a primary wager from the player;
dealing the player a first playing card;
turning one of player's three playing cards face up;
allowing the player to review the first playing card and do one of: (1) place an over wager that the sum of the numerical values of the first playing card and the two additional playing cards will be more than a first numerical value, (2) place an under wager that the sum of the numerical values of the first playing card and the two additional playing cards will be less than a second numerical value, or (3) fold, said allowing step including confiscating the player's primary wager if the player folds;
dealing the player said two additional playing cards; and
settling the player's primary wager, and the player's over wager or the player's under wager, dependent upon the sum of the numerical values of the player's three playing cards.

16. The method of claim 15, wherein:
said settling step including confiscating the player's primary wager and any over wager or under wager made by the player if the sum of the numerical values is any numerical value greater than or equal to the second numerical value, and less than or equal to the first numerical value, regardless of whether the player placed an over wager or placed an under wager;
said settling step including confiscating the player's primary wager and the player's over wager if the sum of the numerical values is less than or equal to the first numerical value and the player placed an over wager;
said settling step including confiscating the player's primary wager and the player's under wager if the sum of the numerical values is greater than or equal to the second numerical value and the player placed an under wager;
said settling step including paying the player a winning payout associated with the player's primary wager and the player's under wager if the sum of the numerical values is less than the second numerical value and the player placed an under wager; and
said settling step including paying the player a winning payout associated with the player's primary wager and the player's over wager if the sum of the numerical values is greater than the first numerical value and the player placed an over wager.

17. The method of claim 15, wherein the first numerical value is 23, wherein the second numerical value is 18.

18. The method of claim 15, further comprising accepting a bonus wager from the player.

19. The method of claim 18, wherein:
said settling step including confiscating the player's bonus wager if the sum of the numerical values is any numerical value greater than or equal to the second numerical value, and less than or equal to the first numerical value;
said settling step including confiscating the player's bonus wager if the sum of the numerical values is less than or equal to the first numerical value and the player placed an over wager;
said settling step including confiscating the player's bonus wager if the sum of the numerical values is greater than or equal to the second numerical value and the player placed an under wager;
said settling step including paying the player a winning payout associated with the player's bonus wager if the sum of the numerical values is less than the second numerical value and the player placed an under wager; and
said settling step including paying the player a winning payout associated with the player's bonus wager if the sum of the numerical values is greater than the first numerical value and the player placed an over wager.

20. The method of claim 19, wherein the first numerical value is 23, and wherein the second numerical value is 18.
